(19) United States
(12) Patent Application Publication
(10) Pub. No.: US 2004/0125227 A1
(43) Pub. Date: Jul. 1, 2004

(54) Camera module

(76) Inventors: Hidekazu Tsuruoka, Kasakake (JP); Koji Shida, Takasaki (JP); Toshihiro Nakai, Saitama (JP); Hidehito Yamada, Saku (JP); Takahisa Funai, Tamamura (JP)

Correspondence Address: REED SMITH LLP, 3110 FAIRVIEW PARK DRIVE, SUITE 1400, FALLS CHURCH, VA, 22042, US

(21) Appl. No.: 10/694,795

(22) Filed: Oct. 29, 2003

(30) Foreign Application Priority Data
Nov. 13, 2002 (JP) 2002-329211

(51) Int. Cl. H04N 5/225

(52) U.S. Cl. 348/340

(57) ABSTRACT

There is provided a camera module of a lens integrated type which can correct limb darkening in operation processing of an electronic circuit by actively employing the technique of shading correction. A camera module of a lens integrated type incorporating a lens, an image sensor and an image processing circuit, wherein the image processing circuit has correction means using, as a correction value, a value obtained by raising the distance from the central axis of an optical system including the lens to the second power to correct a light intensity corresponding to the pixel position of the image sensor. A multiplier constructing the correction means receives, as an input, distance X from the horizontal center to compute X². A multiplier receives, as an input, distance Y from the vertical center to compute Y². The computed X² and Y² are inputted to an adder to compute the second power value R² of the distance from the optical axis. A multiplier multiplies R² by coefficient A1 to obtain correction coefficient B1. Limb darkening is corrected by the correction coefficient B1.

### BACKGROUND OF THE INVENTION

The present invention relates to a camera module. More specifically, the present invention relates to a technique effective to be applied to a camera module including an electronic circuit correcting a reduction in limb light quantity caused at photographing according to the distance from the central axis of an optical system.

The present inventors have studied and considered the following technique about a camera module. For example, a camera quipped in a cellular phone or PDA is strongly required to be made smaller. For this reason, a camera module of a lens integrated type incorporating a lens, an image sensor and an image processing circuit has been developed. In such cameral module of a lens integrated type, the distance between the lens and the image sensor is limited.

### SUMMARY OF THE INVENTION

The present inventors have studied the above-described camera module and the following is apparent.

As the requirement to make the above-described camera module of a lens integrated type smaller is stronger, the distance between the lens and the image sensor is not enough. The light quantity in the limb portion is reduced as compared with the portion near the central axis of the optical system. That is, a light quantity drop (limb darkening) is significantly found.

Coping with such limb darkening in the optical system is a basic measure, which largely affects the cost in a manner such that the number of parts is increased. For example, in an imaging system such as an image scanner, a technique called shading correction is generally employed. Since image quality is not much emphasized in portable terminal equipment such as a cellular phone or PDA, the technique of shading correction is not employed.

Accordingly, an object of the present invention is to provide a camera module of a lens integrated type which can correct limb darkening in computation processing of an electronic circuit by actively employing the technique of shading correction.

The above and other objects and novel features of the present invention will be apparent from the description of this specification and the accompanying drawings.

Representative inventions disclosed in the present invention will be briefly described as follows.

The present invention is applied to a camera module of a lens integrated type incorporating a lens, an image sensor and an image processing circuit and has the following features.

(1) The image processing circuit comprises correction means using, as a correction value, a value obtained by raising the distance from the central axis of an optical system including the lens to the second power to correct a light intensity corresponding to the pixel position of the image sensor. Further, the correction means obtains the correction value by adding a value (X²) obtained by raising the distance from the central axis of the optical system in the horizontal direction to the second power and a value (Y²) obtained by raising the distance from the central axis of the optical system in the vertical direction to the second power, and further obtains it by concentric distance computation. In particular, the camera module has a nonvolatile memory storing the correction value as a function corresponding to the characteristic of an optical system including the lens or a volatile memory rewritable from outside. A correction value is computed in computation processing of an electronic circuit realizing the correction means. Limb darkening can be corrected by the correction value.

(2) The image processing circuit has correction means using, as a correction value, a value obtained by concentric distance computation from the central axis of an optical system including the lens to correct a light intensity corresponding to the pixel position of the image sensor. As in the (1), limb darkening can be corrected by a correction value computed by computation processing of an electronic circuit.

(3) The image processing circuit has correction means using, as a correction value, a value obtained by multiplying one (X²/Y²) of a value obtained by raising the distance from the central axis of an optical system including the lens in the horizontal direction to the second power and a value obtained by raising the distance from the central axis of the optical system in the vertical direction to the second power by a predetermined coefficient to correct a light intensity corresponding to the pixel position of the image sensor. Further, the correction means uses, as a correction value, a value obtained by multiplying the other (Y²/X²) of a value obtained by raising the distance from the central axis of the optical system in the horizontal direction to the second power and a value obtained by raising the distance from the central axis of the optical system in the vertical direction to the second power by a predetermined coefficient, or uses, as a correction value, a value (Y) of the distance from the central axis of the optical system in the vertical direction or a value (X) of the distance from the central axis of the optical system in the horizontal direction of the other (Y²/X²) of a value obtained by raising the distance from the central axis of the optical system in the horizontal direction to the second power and a value obtained by raising the distance from the central axis of the optical system in the vertical direction to the second power by a predetermined coefficient. As in the (1), limb darkening can be corrected by a correction value computed in computation processing of an electronic circuit.

(4) The camera module has selection means selecting the output of the image sensor and the output of the image processing circuit for output. In particular, the image processing circuit has correction means correcting a light intensity corresponding to the pixel position of the image sensor according to the distance from the central axis of an optical system including the lens. When acquiring correction information, the output of the image processing circuit is switched to the output of the image sensor to easily acquire characteristic data of the optical system from an ordinary data output terminal.

### BRIEF DESCRIPTION OF THE DRAWINGS

FIG. 1 is a cross-sectional view showing a camera module of one embodiment of the present invention;

FIGS. 2(a) and 2(b) are an explanatory view showing an imaging system and an explanatory view showing limb darkening, respectively, in a camera module of one embodiment of the present invention;

FIGS. 3(a), 3(b) and 3(c) are a characteristic diagram showing the state of limb darkening, a characteristic diagram showing correction coefficients, and a characteristic diagram showing correction operation respectively, in the light quantity characteristic of an imaging system in a camera module of one embodiment of the present invention;

FIG. 4 is a construction diagram of assistance in explaining operation of horizontal and vertical counters of an image sensor and a signal processing circuit in a camera module of one embodiment of the present invention;

FIG. 5 is a construction diagram of a camera module of one embodiment of the present invention when computing distance X from the optical axis in the horizontal direction and distance Y from the optical axis in the horizontal direction;

FIG. 6 is a construction diagram of a camera module of one embodiment of the present invention when computing the second power of the distance from the optical axis using distance X and distance Y to multiply it by a suitable coefficient for computing a correction coefficient;

FIG. 7 is a construction diagram of a camera module of one embodiment of the present invention when multiplying independent coefficients in the horizontal and vertical directions to compute a correction coefficient;

FIG. 8 is a construction diagram of a camera module of one embodiment of the present invention when approximation with the first power is suitable than that with the second power in any one of the horizontal and vertical directions;

FIG. 9 is a construction diagram of a camera module of one embodiment of the present invention when a nonvolatile memory has a correction coefficient to the distance from the optical center;

FIG. 10 is a construction diagram of a camera module of one embodiment of the present invention when an electrically rewritable memory is replaced to simply switch correction coefficients by the change of an optical system;

FIG. 11 is a construction diagram of a camera module of one embodiment of the present invention when a correction coefficient is used to correct image data from an image sensor for obtaining image data which has corrected limb darkening; and

FIG. 12 is a construction diagram of assistance in explaining a functional construction in a camera module of one embodiment of the present invention, a mechanism for obtaining characteristic data of an optical system, and a procedure for incorporating the fetched characteristic data into a signal processing integrated circuit as a table.

### DETAILED DESCRIPTION OF THE PREFERRED EMBODIMENTS

An embodiment of the present invention will be described below in detail based on the drawings. In all the drawings of assistance in explaining the embodiment, members having the same function are indicated by similar reference numerals, and the repeated description is omitted.

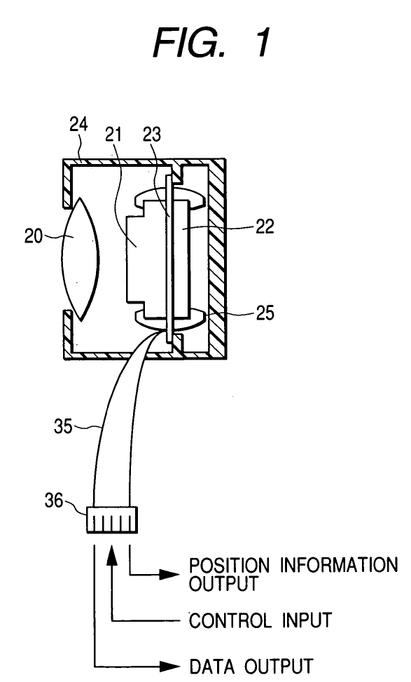

Referring to FIG. 1, an example of the construction of a camera module of one embodiment of the present invention will be described. FIG. 1 shows a cross-sectional view of a camera module of this embodiment.

The camera module of this embodiment is used for portable terminal equipment such as a cellular phone or PDA and is constructed as a camera module of a lens integrated type which incorporates a lens 20 focusing the photographed image of an object onto a sensor plane, an image sensor 21 photographing the object for conversion to image data, a signal processing integrated circuit (image processing circuit) 22 signal-processing the image data of the image sensor 21, and a substrate 23 mounting the image sensor 21 and the signal processing integrated circuit 22, into a housing 24.

The camera module is incorporated into the housing 24 of several millimeters square, and to minimize it, there is generally used a technique used when packaging an integrated circuit, such as wire bonding by metal fine wires 25 for electric connection wiring between a connection terminal of the image sensor 21 and the signal processing integrated circuit 22 and a connection terminal of the substrate 23.

To perform information transmission of the camera module and the outside, a connector 36 is connected via a cable 35. Through the connector 36, output of data in normal operation and position information, and control input from outside are performed.

In the thus-constructed camera module, by way of example, a CMOS sensor having arrayed MOS transistors is used as the image sensor 21. The signal processing integrated circuit 22 is formed on one semiconductor substrate such as a single crystal silicon by the known semiconductor integrated circuit manufacturing technique and is one LSI.

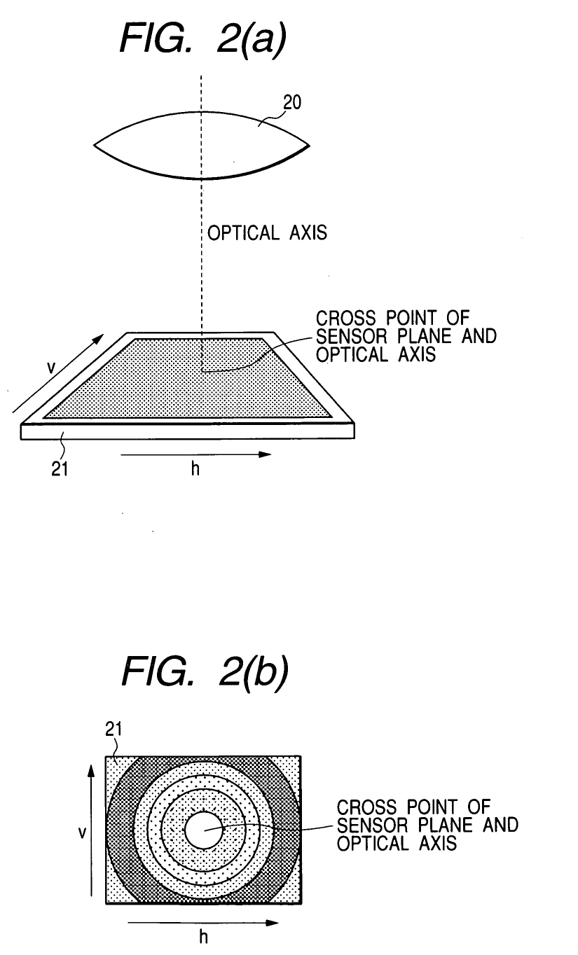

Referring to FIG. 2, an example of an imaging system in the camera module of this embodiment will be described. FIG. 2 simply shows the imaging system. FIG. 2(a) shows an explanatory view of the imaging system. FIG. 2(b) shows an explanatory view of limb darkening.

As shown in FIG. 2(a), in the camera module, a light which has passed through an optical system such as the lens 20 is focused onto a photosensitive device such as the image sensor 21 to process image data as the output of the image sensor 21 at a later stage, thereby obtaining image data. Here, a straight line passing through the center of the lens 20 to the image sensor 21 is called an optical axis.

In FIG. 2(b), a light quantity detected by the image sensor 21 is expressed by brightness, and the darkening stage is simply shown. In general, in the state that a uniform light is incident, the limb light quantity is reduced concentrically with respect to the cross point of the sensor plane and the optical axis. That is, the limb darkening depends on the distance from the optical axis on the image sensor 21 and has the same characteristic in any direction when the distances are the same. The position on the screen is indicated by coordinate h in the horizontal direction and coordinate v in the vertical direction.

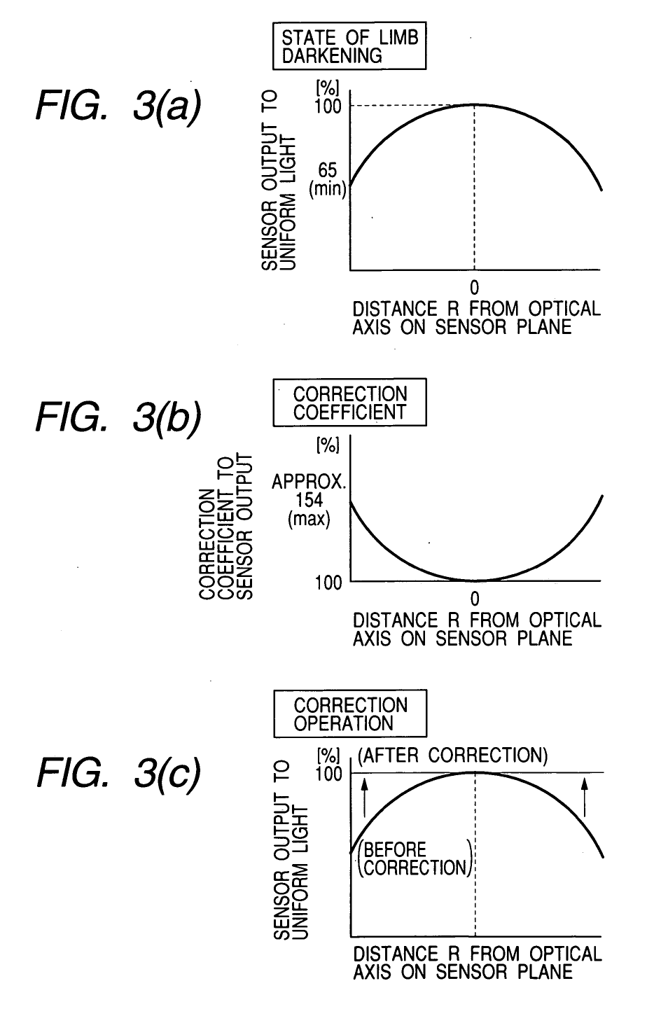

Referring to FIG. 3, an example of the light quantity characteristic of the imaging system of the camera module of this embodiment will be described. FIG. 3 shows the light quantity characteristic of the imaging system. FIG. 3(a) shows a characteristic diagram of the state of limb darkening. FIG. 3(b) shows a characteristic diagram of a correction coefficient. FIG. 3(c) shows a characteristic diagram of correction operation.

In FIG. 3(a), the characteristic of limb darkening is shown at the ratio of a light quantity to the cross point of the sensor plane and the optical axis. That is, it shows, in the state that a uniform light is incident, a characteristic curve of the sensor output to distance R from the optical axis on the sensor plane. As understood from this drawing, in the case of sensor output=100% at distance R=0 from the optical axis on the sensor plane, darkening is performed to about 65% at the minimum in the limb part.

Inverse computation is performed from the characteristic to obtain the correction coefficient such as FIG. 3(b) to multiply the characteristic of FIG. 3(a) by it. That is, a reduction in light quantity in the optical system according to the curve called the so-called cos fourth power law is multiplied by, as a correction amount, the curve of R² with approximation in proportion to the second power of the distance R from the optical axis so as to be about 154% at the maximum in the limb portion in the case of correction coefficient=100% at distance R=0 from the optical axis on the sensor plane.

For the light quantity characteristic of correction operation, a uniform output characteristic as shown in FIG. 3(c) can be obtained. Darkening to about 65% in the limb portion before correction can be corrected for operation so that after correction, in the case of sensor output=100% at distance R=0 from the optical axis on the sensor plane, sensor output=100% is also given in the limb portion.

When the output characteristic is corrected to be uniform, a noise component included in image information may be amplified. In this case, in view of visually checked limb darkening, it is corrected to the level to minimize the problem. Constructions for realizing limb darkening correction will be described below.

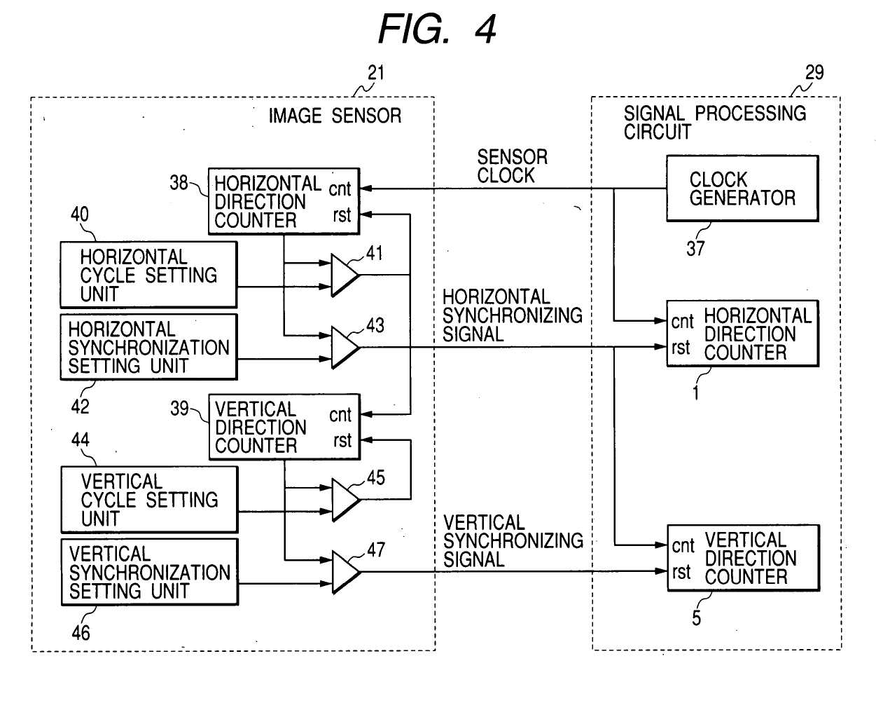

Referring to FIGS. 4 to 11, construction examples of correction means (electronic circuits) for realizing limb darkening correction in the camera module of this embodiment will be described in order.

FIG. 4 is a construction example of assistance in explaining the operation of the horizontal and vertical counters of the image sensor and the signal processing circuit in realizing limb darkening correction.

In the construction of FIG. 4, the image sensor 21 has a horizontal direction counter 38, a vertical direction counter 39, a horizontal cycle setting unit 40, a comparator 41, a horizontal synchronization setting unit 42, a comparator 43, a vertical cycle setting unit 44, a comparator 45, a vertical synchronization setting unit 46, and a comparator 47. A signal processing circuit 29 in the signal processing integrated circuit 22 will be described later in detail and has a horizontal direction counter 1, a vertical direction counter 5, and a clock generator 37.

In the above construction, a clock generated by the clock generator 37 in the signal processing circuit 29 is inputted to the horizontal direction counter 38 of the image sensor 21 and the horizontal direction counter 1 of the signal processing circuit 29. The respective counters perform counting-up by the clock. In general, the clock coincides with the pixel in the horizontal direction.

A horizontal cycle set value is set to the horizontal cycle setting unit 40 of the image sensor 21. The comparator 41 compares this with a value of the horizontal direction counter 38. When the values are matched with each other, the value of the horizontal direction counter 38 is cleared and the vertical direction counter 39 performs counting-up.

In the same manner, in the vertical direction, there is the vertical cycle setting unit 44 to which a vertical cycle set value is set. The comparator 45 compares the vertical cycle set value with a value of the vertical direction counter 39. When the values are matched with each other, the value of the vertical direction counter 39 is cleared.

The image sensor 21 has the horizontal synchronization setting unit 42. The comparator 43 compares a horizontal synchronization set value set to the horizontal synchronization setting unit 42 with a value of the horizontal direction counter 38. When the values are matched with each other, a horizontal synchronizing signal is generated. The signal processing circuit 29 clears its own horizontal direction counter 1 with reference to the horizontal synchronizing signal.

In the same manner, in the vertical direction, there is the vertical synchronization setting unit 46. The comparator 47 compares a vertical synchronization set value set to the vertical synchronization setting unit 46 with a value of the vertical direction counter 39. When the values are matched with each other, a vertical synchronizing signal is generated. The signal processing circuit 29 clears its own vertical direction counter 5 with reference to the vertical synchronizing signal.

From the above operation, operations of the horizontal and vertical direction counters 38, 39 of the image sensor 21 and the horizontal and vertical direction counters 1, 5 of the signal processing circuit 29 are synchronized with each other. The horizontal and vertical direction counters 38, 39 of the image sensor 21 indicate the coordinates on the sensor plane. The coordinates on the sensor plane can be found from the values of the horizontal and vertical direction counters 1, 5 of the signal processing circuit 29.

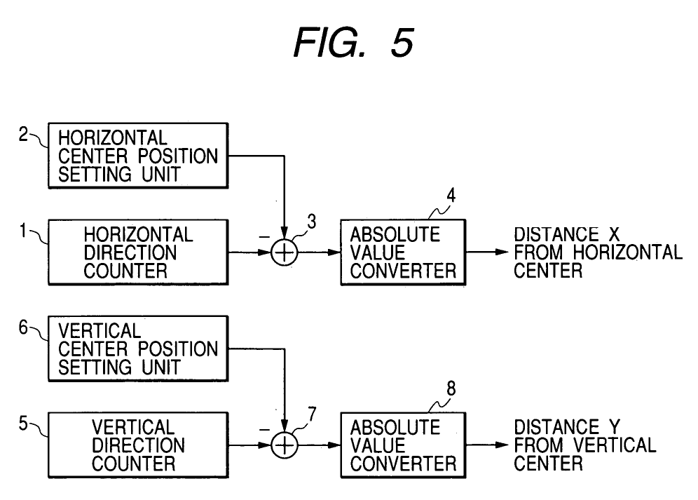

FIG. 5 is a construction example in which distance X from the optical axis in the horizontal direction and distance Y from the optical axis in the horizontal direction are computed from the horizontal and vertical direction counters and the horizontal and vertical center position set values in the signal processing circuit.

The construction of FIG. 5 comprises a horizontal direction counter 1, a horizontal center position setting unit 2, an adder 3, an absolute value converter 4, a vertical direction counter 5, a vertical center position setting unit 6, an adder 7, and an absolute value converter 8.

In the horizontal direction, the horizontal direction counter 1 indicates the coordinate in the horizontal direction by counting the number of pixels in the horizontal direction. The coordinate of the center position in the horizontal direction is set to the horizontal center position setting unit 2. The adder 3 obtains a difference from the values of the horizontal direction counter 1 and the horizontal center position setting unit 2. The absolute value converter 4 obtains an absolute value to compute the distance X from the optical axis in the horizontal direction.

Also in the vertical direction, the vertical direction counter 5 indicates the coordinate in the vertical direction by counting the number of pixels (=the number of lines) in the vertical direction. The coordinate of the center position in the vertical direction is set to the vertical center position setting unit 6. The adder 7 obtains a difference from the values of the vertical direction counter 5 and the vertical center position setting unit 6. The absolute value converter 8 obtains an absolute value to compute the distance Y from the optical axis in the vertical direction.

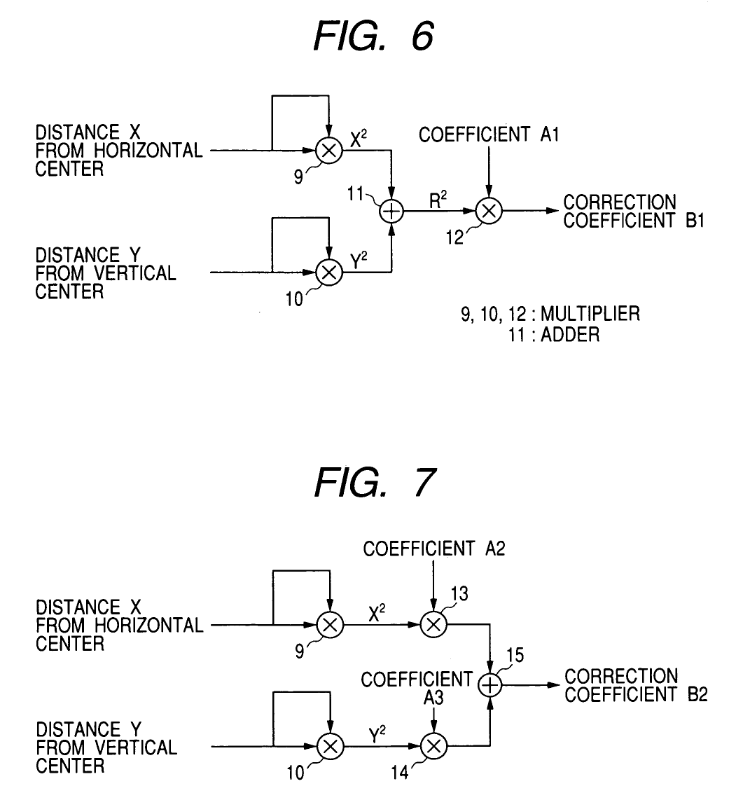

FIG. 6 is a construction example in which the second power of the distance from the optical axis is computed using the distances X and Y computed from the construction of FIG. 5 to multiply it by suitable coefficient A1 for computing correction coefficient B1.

The construction of FIG. 6 has a multiplier 9 receiving, as an input, the distance X from the horizontal center, a multiplier 10 receiving, as an input, the distance Y from the vertical center, an adder 11, and a multiplier 12.

The multiplier 9 receives, as an input, the distance X from the horizontal center for multiplication to compute X². The multiplier 10 also receives, as an input, the distance Y from the vertical center for multiplication to compute Y². The multipliers 9, 10 can use one multiplier with time division by adjustment of operation timing and addition of data holding means.

The X² and Y² computed by the multipliers 9, 10 are inputted to the adder 11 to compute second power value R² of the distance from the optical axis. The multiplier 12 multiplies the R² by the coefficient A1 to obtain the correction coefficient B1.

FIG. 7 is a construction example in which in FIG. 6, correction coefficient B2 is computed by multiplying independent coefficients when the darkening characteristics are different in the horizontal and vertical directions.

The construction of FIG. 7 has the same multipliers 9, 10 as those of FIG. 6, a multiplier 13, a multiplier 14, and an adder 15.

The multiplier 13 receives, as an input, the X² computed by the multiplier 9 and coefficient A2 to multiply the X² by the coefficient A2. In the same manner, the multiplier 14 receives, as an input, the Y² computed by the multiplier 10 and coefficient A3 to multiply the Y² by the coefficient A3. The adder 15 adds the outputs of the multipliers 13, 14 to obtain the correction coefficient B2.

Also in the construction, as in FIG. 6, adjustment of operation timing and addition of data holding means unify the multipliers 9, 10 and the multipliers 13, 14, respectively, for use with time division.

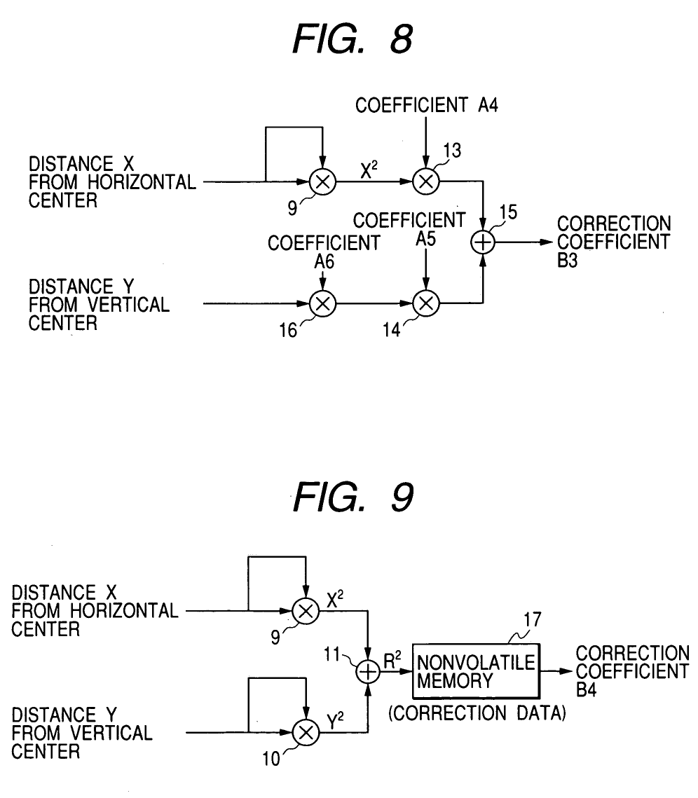

FIG. 8 is a construction example, to FIGS. 6 and 7, applied when approximation with the first power is more suitable than that with the second power in any one of the horizontal and vertical directions. Here, approximation with the first power is made in the characteristic in the vertical direction. Conversely, when approximation with the first power is made in the horizontal direction, the constructions of the X, Y are switched to realize the example.

The construction of FIG. 8 has the same multipliers 9, 13 and 14 and adder 15 as those of FIG. 7, and a multiplier 16.

The multiplier 16 is provided in place of the multiplier 10 of FIG. 7 and multiplies the distance Y from the vertical center by coefficient A6 to input the result to the multiplier 14. The adder 15 adds the output of the multiplier 14 and the output of the multiplier 13 to obtain correction coefficient B3.

In the construction, multiplication by the coefficients A6, A5 is previously performed to unify the multipliers 16, 14. As in FIGS. 6 and 7, adjustment of operation timing and addition of data holding means unify the multipliers 13, 14 for use with time division.

Unlike FIGS. 6 to 8, FIG. 9 is a construction example in which a nonvolatile memory such as a ROM has a correction coefficient with respect to the distance from the optical center obtained from the characteristic of the optical system previously used, as a table with respect to the R².

The construction of FIG. 9 to obtain R² is the same as that of FIG. 6, and has the same multipliers 9, 10 and adder 11 as those of FIG. 6 and a nonvolatile memory 17.

The nonvolatile memory 17 receives, as an input of a correction coefficient table, the R² to obtain the output of the table as correction coefficient B4. Here, a one-to-one correspondence of the R and R² is provided. The table for the R is prepared to convert it to the R².

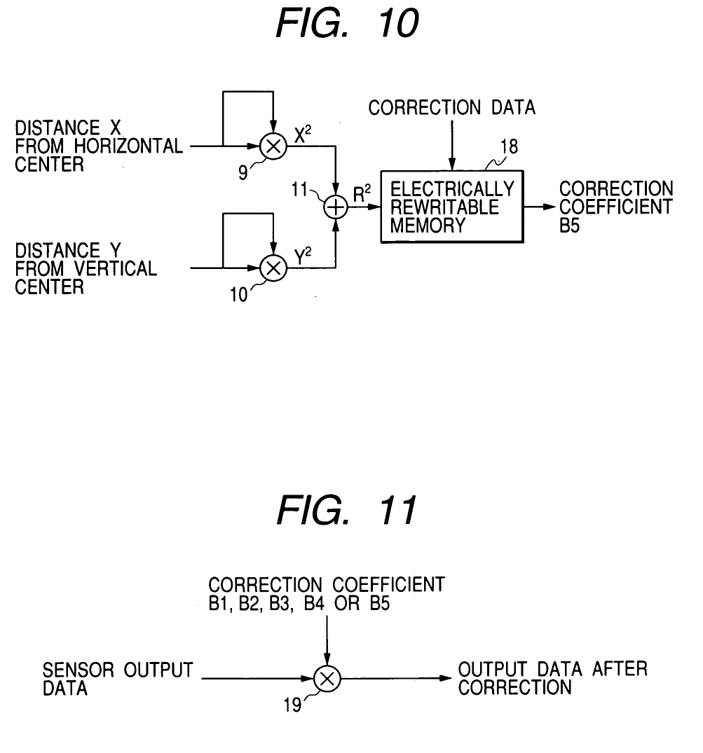

FIG. 10 is a construction example in which the nonvolatile memory of FIG. 9 is replaced by an electrically rewritable memory such as a RAM to simply switch correction coefficients by the change of the optical system without remanufacturing the semiconductor and using special equipment for rewriting the contents.

An electrically rewritable memory 18 in the construction of FIG. 10 has the correction coefficient table receiving, as an input, the R². The correction coefficient table is written from the outside of an LSI. The output of the table is correction coefficient B5.

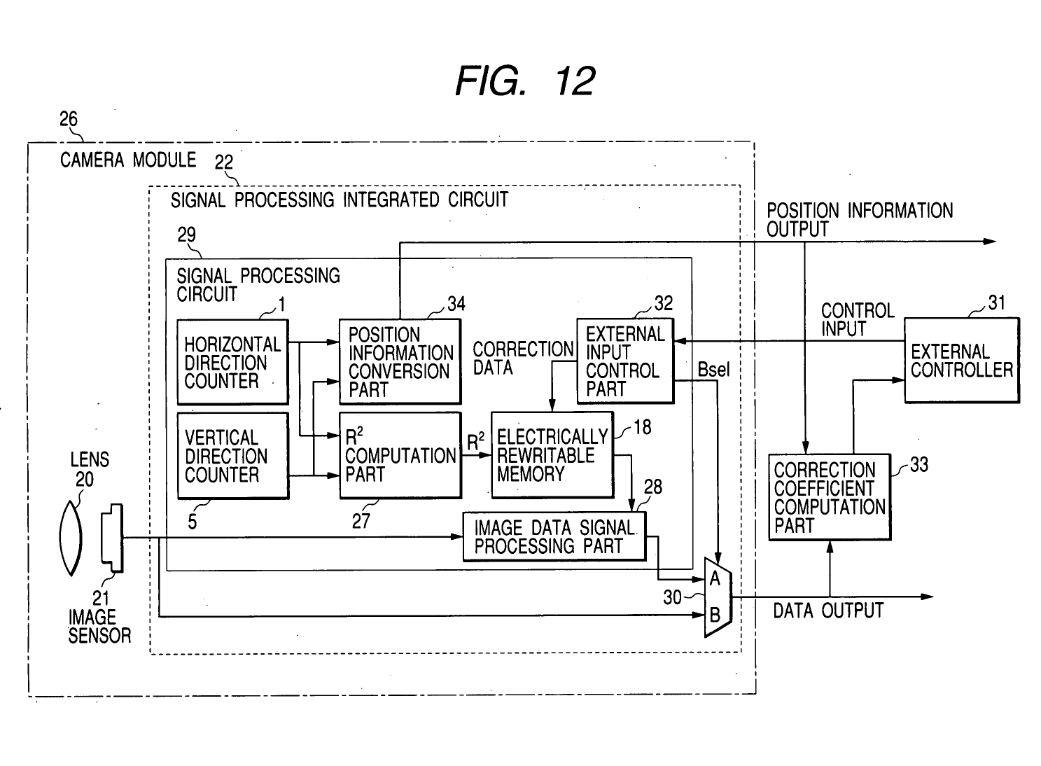

FIG. 11 is a construction example in which the correction coefficients B1, B2, B3, B4 or B5 obtained from FIGS. 6 to 10 are used to correct image data from the image sensor by multiplication in the multiplier for obtaining image data in which limb darkening is corrected.

A multiplier 19 in the construction of FIG. 11 multiplies sensor output data by any one of the correction coefficients B1, B2, B3, B4 and B5 as an input. The output obtained from the multiplier 19 is a characteristic in which limb darkening is corrected and the inputted image data is improved.

The constructions of FIGS. 9, 10 need to obtain the correction coefficient required in the optical system used. However, a camera module incorporated into mobile equipment such as a cellular phone has the following problem and cannot easily obtain characteristic data of the optical system.

The camera module is integrated as a module as shown in FIG. 1. The wiring bonding technique is used for the wiring of the image sensor 21 and the signal processing integrated circuit 22. Manually providing wiring to the completed module is very difficult and is actually impossible. Another output system for fetching data cannot be provided in the module which need to be minimized.

To obtain the characteristic data of the optical system in the camera module, there is required a mechanism in which the characteristic data of the image sensor 21 is placed on the wiring originally existing as the output of the module to obtain necessary data without adding any physical change to the module. A mechanism for obtaining the characteristic data of the optical system and a procedure for incorporating the fetched characteristic data into the signal processing integrated circuit 22 as a table will be described below.

Referring to FIG. 12, there will be described an example of a functional construction in the camera module of this embodiment, a mechanism for obtaining the characteristic data of the optical system, and a procedure for incorporating the fetched characteristic data into the signal processing integrated circuit as a table. FIG. 12 shows a construction diagram of the camera module.

As described above, a camera module 26 has a lens 20, an image sensor 21, and a signal processing integrated circuit 22. The signal processing integrated circuit 22 is formed with a signal processing circuit 29 and a selector 30. The signal processing circuit 29 has a horizontal direction counter 1, a vertical direction counter 5, an electrically rewritable memory 18, an R² computation part 27, an image data signal processing part 28, an external input control part 32, and a position information conversion part 34. The camera module 26 is provided in its outside with an external controller 31 and a correction coefficient computation part 33.

In the camera module 26, the output of the image sensor 21 is connected to input B of the selector 30 and is also connected to the image data signal processing part 28 in the signal processing circuit 29. The output of the image data signal processing part 28 is connected to input A of the selector 30. The output of the selector 30 is connected to the outside and is also connected to the correction coefficient computation part 33 of the outside.

The outputs of the horizontal direction counter 1 and the vertical direction counter 5 are connected to the R² computation part 27 and the position information conversion part 34. The output of the R² computation part 27 is connected to the electrically rewritable memory 18. The output of the electrically rewritable memory 18 is connected to the image data signal processing part 28. The output of the position information conversion part 34 is connected to the outside and is also connected to the correction coefficient computation part 33 of the outside.

The output of the correction coefficient computation part 33 of the outside is connected to the external controller 31. The output of the external controller 31 is connected to the external input control part 32 in the signal processing circuit 29. The output of the external input control part 32 is connected to the electrically rewritable memory 18. The external input control part 32 is connected to a signal line supplying switch signal Bsel to the selector 30.

The horizontal direction counter 1 and the vertical direction counter 5 of the camera module 26 shown in FIG. 12 show the same as those of FIG. 5. The electrically rewritable memory (RAM) 18 is the same as that of FIG. 10. The R² computation part 27 shows together a part excluding the horizontal direction counter 1 and the vertical direction counter 5 of FIG. 5 and the R² computation of FIG. 10. The image data signal processing part 28 is a block performing normal image data signal processing. The multiplier 19 of FIG. 11 is included into this. At normal use, the output of the image data signal processing part 28 is output data of the camera module 26.

The thus-constructed camera module 26 is possible by adding the selector 30 to the existing signal processing circuit including these circuits. This can switch the normal output and the output data of the image sensor 21 for output. The switch instruction is performed from the input system for control from the external controller 31 existing in the existing module.

The switch instruction of the selector 30 from the external controller 31 is outputted as the selector switch signal Bsel through the external input control part 32. At normal output, the Bsel is invalid and the selector 30 selects the input A. At output of the sensor image data, the Bsel is valid to select the input B.

To indicate that from what coordinates data is outputted, the position information conversion part 34 produces a signal indicating position information from the horizontal direction counter 1 and the vertical direction counter 5 for output. The signal line used here is used as horizontal and vertical synchronization at normal output. When there is no trouble for use, the same signal as that at normal use may be outputted.

The correction coefficient computation part 33 acquires sensor image data according to the output of the position information to compute correction data. The correction data need not be computed timely and a form to realize the correction coefficient computation part 33 is not particularly defined.

When computing correction data from the sensor image data, in the state that a uniform light is incident from the lens 20 of the camera module 26, image data is acquired from the image sensor 21. After normalizing the entire by data near the optical axis, an inverse number is obtained. Addition and subtraction are performed in view of a noise amount to provide final correction data. In this case, variation between the sensor devices must be considered.

The correction data is written from the external controller 31 through the external input control part 32 into the electrically rewritable memory 18 such as a RAM at the start of the camera module 26. In this case, when the correction data must be changed, the change of the module is unnecessary.

Alternatively, an external nonvolatile memory is added to the camera module 26 to read table data by the control from the signal processing integrated circuit 22. A mechanism reading data must be incorporated into the signal processing integrated circuit 22. In this case, it is essential only that the contents written into the nonvolatile memory be changed. The cost can be reduced significantly as compared with remanufacturing of the integrated circuit.

The construction of FIG. 9 uses the nonvolatile memory 17. The correction data is incorporated when designing or manufacturing the signal processing integrated circuit 22. Naturally, writing of the correction data is unnecessary at start.

As described above, the camera module of this embodiment has the constructions as shown in FIGS. 4 to 11. It has correction means using a correction value based on the distance from the central axis of the optical system including the lens 20 to correct a light intensity corresponding to the pixel position of the image sensor 21. A light quantity drop in the limb part is eliminated or is reduced to make the characteristic to the brightness of the entire screen uniform or bring it close to uniform.

As a result, due to correction by the electronic circuit, increase of the number of parts of the optical system and increase of size can be reduced. The construction directly outputting input data to the output terminal can easily acquire the characteristic data of the optical system from the ordinary data output terminal in the module integrating the lens 20 and the image sensor 21. The acquired characteristic data can be incorporated into the signal processing integrated circuit 22 as the table.

The inventions which have been made by the present inventors are specifically described above based on the embodiment. Needless to say, the present invention is not limited to the embodiment and various modifications can be made within the scope without departing from its purpose.

As exemplified in the embodiment, the camera module of the present invention is used in portable terminal equipment such as a cellular phone or PDA, and in particular, can be applied preferably to equipment such as portable terminal equipment which is required to be made smaller.

Effects obtained by the representative inventions disclosed in the present invention will be briefly described as follows.

(1) In a camera module of a lens integrated type, the image processing circuit has correction means using, as a correction value, a value obtained by raising the distance from the central axis of an optical system including the lens to the second power to correct a light intensity corresponding to the pixel position of the image sensor. Limb darkening can be corrected by a correction value computed in operation processing of an electronic circuit. The characteristic to the brightness of the entire screen can be uniform.

(2) In a camera module of a lens integrated type, the image processing circuit has correction means using, as a correction value, a value obtained by concentric distance computation from the central axis of an optical system including the lens to correct a light intensity corresponding to the pixel position of the image sensor. As in the (1), limb darkening can be corrected in operation processing of an electronic circuit. The characteristic to the brightness of the entire screen can be uniform.

(3) In a camera module of a lens integrated type, the image processing circuit has correction means using, as a correction value, a value obtained by multiplying one of a value obtained by raising the distance from the central axis of an optical system including the lens in the horizontal direction to the second power and a value obtained by raising the distance from the central axis of the optical system in the vertical direction to the second power by a predetermined coefficient to correct a light intensity corresponding to the pixel position of the image sensor. As in the (1), limb darkening can be corrected in operation processing of an electronic circuit. The characteristic to the brightness of the entire screen can be uniform.

(4) From the (1) to (3), limb darkening can be corrected in operation processing of an electronic circuit. It is possible to provide a camera module of a lens integrated type which can reduce increase of the number of parts of the optical system and increase of size.

(5) The camera module has selection means selecting the output of the image sensor and the output of the image processing circuit for output. In the camera module of a lens integrated type, when acquiring correction information, the output of the image sensor is switched to the output of the image processing circuit to easily acquire characteristic data of the optical system from the ordinary data output terminal. Further, the acquired characteristic data can be incorporated into the image processing circuit as the table.

What is claimed is:

1. A camera module of a lens integrated type incorporating a lens, an image sensor and an image processing circuit,
wherein said image processing circuit has correction means using, as a correction value, a value obtained by raising the distance from the central axis of an optical system including said lens to the second power to correct a light intensity corresponding to the pixel position of said image sensor.

2. The camera module according to claim 1, wherein said correction means obtains said correction value by adding a value obtained by raising the distance from the central axis of said optical system in the horizontal direction to the second power and a value obtained by raising the distance from the central axis of said optical system in the vertical direction to the second power.

3. The camera module according to claim 2, wherein said correction means obtains said correction value by concentric distance computation by adding a value obtained by raising the distance from the central axis of said optical system in the horizontal direction to the second power and a value obtained by raising the distance from the central axis of said optical system in the vertical direction to the second power.

4. The camera module according to claim 3, further comprising a nonvolatile memory storing said correction value as a function corresponding to the characteristic of an optical system including said lens.

5. The camera module according to claim 3, further comprising a volatile memory rewritable from outside and storing said correction value as a function corresponding to the characteristic of an optical system including said lens.

6. A camera module of a lens integrated type incorporating a lens, an image sensor and an image processing circuit,
wherein said image processing circuit has correction means using, as a correction value, a value obtained by concentric distance computation from the central axis of an optical system including said lens to correct a light intensity corresponding to the pixel position of said image sensor.

7. A camera module of a lens integrated type incorporating a lens, an image sensor and an image processing circuit,
wherein said image processing circuit has correction means using, as a correction value, a value obtained by multiplying a value obtained by raising the distance from the central axis of an optical system including said lens in the horizontal direction to the second power or a value obtained by raising the distance from the central axis of said optical system in the vertical direction to the second power by a predetermined coefficient to correct a light intensity corresponding to the pixel position of said image sensor.

8. The camera module according to claim 7, wherein said correction means uses, as a correction value, a value obtained by multiplying the other of a value obtained by raising the distance from the central axis of said optical system in the horizontal direction to the second power or a value obtained by raising the distance from the central axis of said optical system in the vertical direction to the second power by a predetermined coefficient.

9. The camera module according to claim 7, wherein said correction means uses, as a correction value, a value obtained by multiplying a value of the distance from the central axis of said optical system in the vertical direction or a value of the distance from the central axis of said optical system in the horizontal direction, of the other of a value obtained by raising the distance from the central axis of said optical system in the horizontal direction to the second power and a value obtained by raising the distance from the central axis of said optical system in the vertical direction to the second power by a predetermined coefficient.

10. A camera module of a lens integrated type incorporating a lens, an image sensor and an image processing circuit, further comprising selection means selecting the output of said image sensor and the output of said image processing circuit for output.

11. The camera module according to claim 10, wherein said image processing circuit has correction means correcting a light intensity corresponding to the pixel position of said image sensor according to the distance from the central axis of an optical system including said lens.
